(19) United States
(12) Patent Application Publication
(10) Pub. No.: US 2026/0115613 A1
(43) Pub. Date: Apr. 30, 2026

(54) ASSEMBLY SUPPORT TOOL FOR FUSIBLE TOY BEAD

(71) Applicant: EPOCH COMPANY, LTD., Tokyo (JP)

(72) Inventor: Ryo SAKAI, Tokyo (JP)

(73) Assignee: EPOCH COMPANY, LTD., Tokyo (JP)

(21) Appl. No.: 19/372,884

(22) Filed: Oct. 29, 2025

(30) Foreign Application Priority Data
Oct. 31, 2024 (JP) 2024-191468

(51) Int. Cl. A63H 33/00

(52) U.S. Cl. CPC A63H 33/001

(57) ABSTRACT

An assembly support tool for a fusible toy bead, the assembly support tool includes a first mold member including a first cavity, a second mold member including a second cavity, and a hinge portion connecting the first mold member and the second mold member such that the first mold member and the second mold member are able to be closed or opened. The first cavity and the second cavity include a plurality of bead placing portions for positioning the fusible toy bead.

### CROSS-REFERENCE TO RELATED APPLICATIONS

This application is based on and claims priority under 35 USC 119 from Japanese Patent Application No. 2024-191468 filed on October 31, 2024, the entire content of which is incorporated herein by reference.

### TECHNICAL FIELD

The present disclosure relates to an assembly support tool for a fusible toy bead.

### BACKGROUND ART

An assembly support tool for storing a fusible toy bead has been proposed. For example, JP2009-125232A discloses a flat bead holding tray (assembly support tool) that can be used to arrange fusible toy beads to produce an assembly of any shape. The assembly produced using the bead holding tray is, for example, produced in a strip shape. It is described that the strip-shaped assembly can be curved using a tubular portion to form a three-dimensional shape.

However, when the three-dimensional assembly is produced using the assembly support tool described in JP2009-125232A, a plurality of steps are required, such as first producing and drying a planar assembly, and then fixing the assembly in a bent state or stacking a plurality of assemblies. Therefore, producing a three-dimensional assembly requires a lot of time and effort.

An object of the present disclosure is to provide an assembly support tool for a fusible toy bead that can easily produce a three-dimensional assembly.

### SUMMARY

An assembly support tool for a fusible toy bead, the assembly support tool includes a first mold member including a first cavity, a second mold member including a second cavity, and a hinge portion connecting the first mold member and the second mold member such that the first mold member and the second mold member are able to be closed or opened. The first cavity and the second cavity include a plurality of bead placing portions for positioning the fusible toy bead.

According to the present disclosure, an assembly support tool for a fusible toy bead that can easily produce a three-dimensional assembly can be provided.

### BRIEF DESCRIPTION OF DRAWINGS

FIG. 1 is a planar perspective view of an assembly support tool according to a first embodiment;

FIG. 2 is a bottom perspective view of the assembly support tool according to the first embodiment;

FIG. 3 is a diagram showing the assembly support tool in a closed state;

FIG. 4 is a planar perspective view of an assembly support tool according to a second embodiment; and

FIG. 5 is a bottom perspective view of the assembly support tool according to the second embodiment.

### DESCRIPTION OF EMBODIMENTS

### First Embodiment

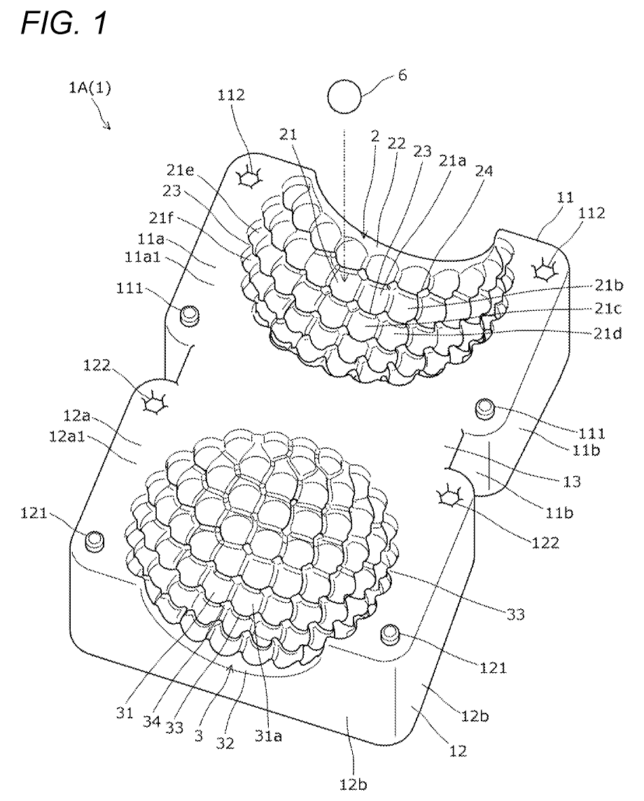

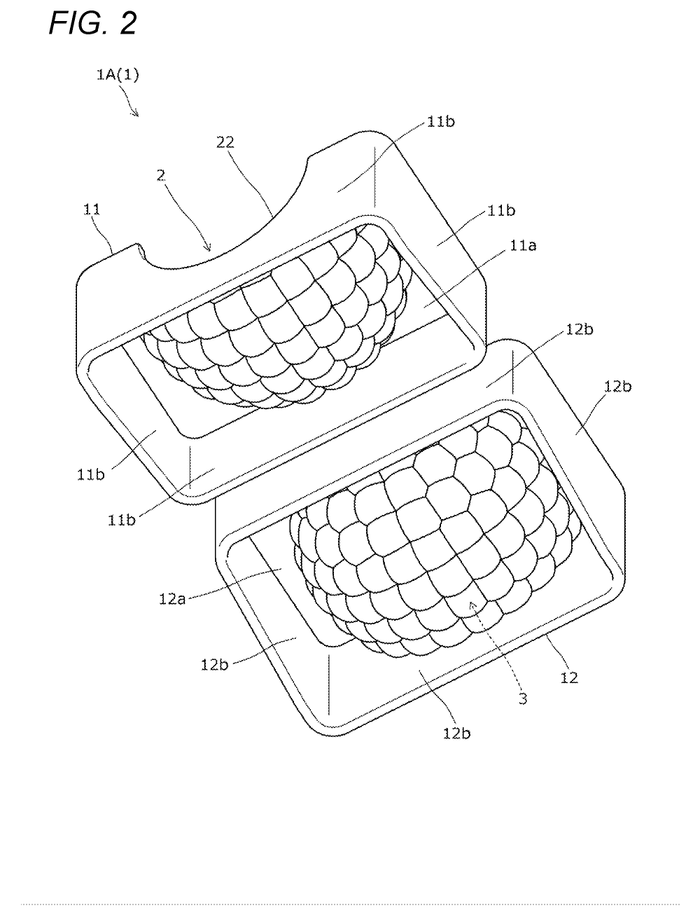

First, a first embodiment of the present disclosure will be described with reference to FIGS. 1 to 3. FIG. 1 is a planar perspective view of an assembly support tool 1A (1) according to the first embodiment. FIG. 2 is a bottom perspective view of the assembly support tool 1A according to the first embodiment. The assembly support tool 1A in FIGS. 1 and 2 shows a state in which a hinge portion 13 is extended and a mold is opened (unfolded state).

The assembly support tool 1A is a support tool for producing a three-dimensional assembly by arranging substantially spherical fusible toy beads 6 adjacent to each other and fusing the fusible toy beads 6 together.

The fusible toy beads 6 are made of a resin, which is a water-soluble material. Specifically, the fusible toy beads 6 are formed by blending and kneading polyvinyl alcohol with resin. The resin for forming the fusible toy beads can freely select a transparent material, a translucent material, or an opaque material. The fusible toy beads are formed in an approximately spherical shape, and various shapes, such as a spherical shape, a convex polyhedron (a regular triacontahedron or the like), or a concave polyhedron (a star shape or the like), can be used.

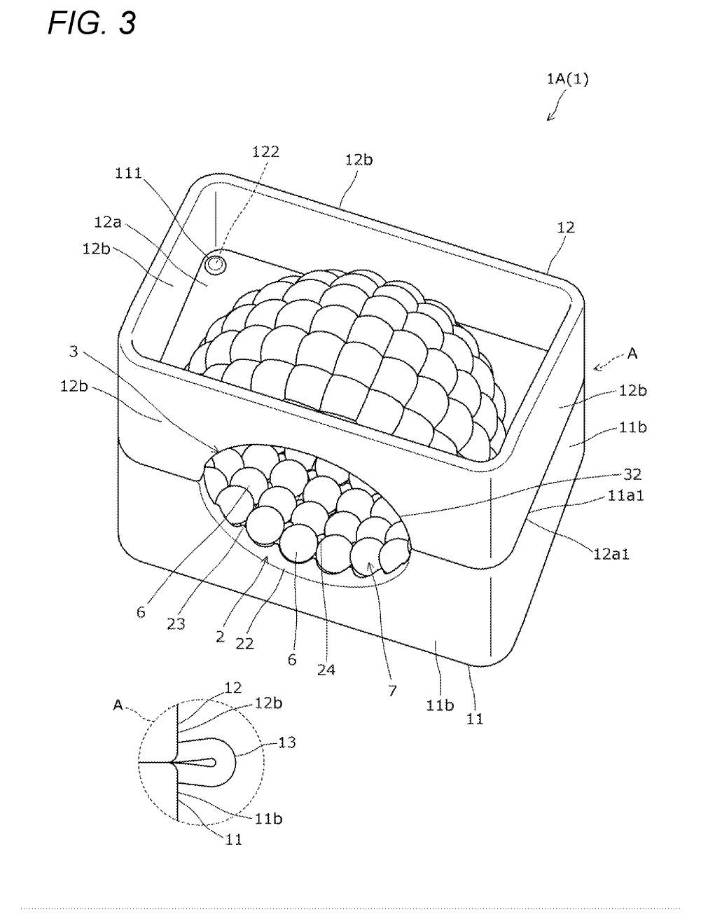

The assembly support tool 1A includes a first mold member 11 having a first cavity 2, a second mold member 12 having a second cavity 3, and the hinge portion 13 connecting the first mold member 11 and the second mold member 12 such that the first mold member 11 and the second mold member 12 can be closed (as shown in FIG. 3) or opened (as shown in

FIG. 1). The assembly support tool 1A is made of a hard or flexible material (for example, resin).

The first mold member 11 and the second mold member 12 are formed in a trapezoidal column shape which is substantially trapezoidal in a side view. The first mold member 11 and the second mold member 12 respectively include base plates 11a and 12a having mold contact surfaces 11a1 and 12a1, and side walls 11b and 12b having a rectangular frame shape and extending from outer peripheral edges of the base plates 11a and 12a (see also FIG. 2).

The first mold member 11 has positioning protrusions 111 (first engaging portions) and positioning holes 112 (first engaged portions) on the mold contact surface 11a1 where the first cavity 2 is formed. The positioning protrusions 111 and the positioning holes 112 are provided outside an outer peripheral edge of the first cavity 2 and at four corners of the mold contact surface 11a1.

The positioning protrusions 111 of the first mold member 11 are provided on a hinge portion 13 side. Each of the positioning protrusions 111 is formed in a substantially cylindrical shape. The positioning holes 112 of the first mold member 11 are provided with respect to the positioning protrusions 111 and on a side opposite to (side farther from) the hinge portion 13. Each of the positioning holes 112 is a substantially polygonal through hole.

In the present embodiment, the first cavity 2 is formed in a concave shape, recessed like a spherical segment overall. An inner diameter of the first cavity 2 is set large enough to allow a three-dimensional assembly of the fusible toy beads 6 to be formed. For example, the inner diameter of the first cavity 2 and an inner diameter of the second cavity 3 (described below) are set long enough such that the fusible toy beads 6 in bead placing portions 21a located at the bottom of the first cavity 2 do not come into contact with the fusible toy beads 6 in the bead placing portion 31a located at the bottom of the second cavity 3 (for example, depths of the first cavity 2 and the second cavity 3 are each at least 1.5 times a depth of the fusible toy beads 6).

The first mold member 11 has a first notch portion 22 adjacent to the first cavity 2 and connecting to an external space. The first notch portion 22 has a cutout edge that is concavely curved in a semicircular arc.

The first cavity 2 includes a plurality of bead placing portions 21 that position the fusible toy beads 6. Each of the bead placing portions 21 is formed in a concave shape, recessed and curved like a spherical segment with an inner diameter substantially the same as an outer diameter of the fusible toy bead 6, and the periphery of the bead placing portion 21 is surrounded like a bank. Adjacent bead placing portions 21 (for example, bead placing portions 21a to 21d) inside the first cavity 2 are partitioned by partition walls 23 that are curved in a concave arc.

Protruding walls 24 higher than the partition walls 23 are formed at boundaries between the plurality (for example, three or four or more) of adjacent bead placing portions 21 located inside the first cavity 2. The bead placing portion 21 is surrounded by the partition wall 23 or the protruding wall 24, and thus the bead placing portion 21 can stably support the fusible toy bead 6 even at an inclined position within the first cavity 2.

Adjacent bead placing portions 21 (for example, bead placing portions 21e and 21f) at the edge portion of the first cavity 2 are also partitioned by the partition wall 23.

The second mold member 12 includes, on a mold contact surface 12a1 where the second cavity 3 is formed, positioning protrusions 121 (second engaging portions) that can be engaged with and disengaged from the positioning holes 112 (first engaged portions) of the first mold member 11, and positioning holes 122 (second engaged portions) that can be engaged with and disengaged from the positioning protrusions 111 (first engaging portions) of the first mold member 11. The positioning protrusions 121 and the positioning holes 122 are provided outside an outer peripheral edge of the second cavity 3 and at four corners of the mold contact surface 12a1.

The positioning holes 122 of the second mold member 12 are provided on the hinge portion 13 side. The positioning protrusions 121 of the second mold member 12 are provided with respect to the positioning holes 122 and on a side opposite to (side farther from) the hinge portion 13.

The second cavity 3 is configured similarly to the first cavity 2. That is, the second cavity 3 is formed in a concave shape, recessed like a spherical segment overall. The inner diameter of the second cavity 3 is also set large enough to allow a three-dimensional assembly of the fusible toy beads 6 to be formed.

The second mold member 12 has a second notch portion 32 adjacent to the second cavity 3 and connecting to an external space. The second notch portion 32 has a cutout edge that is concavely curved in a semicircular arc.

The second cavity 3 includes a plurality of bead placing portions 31 that position the fusible toy beads 6. Similar to the bead placing portions 21, each of the bead placing portions 31 is formed in a concave shape, recessed and curved like a spherical segment with an inner diameter substantially the same as an outer diameter of the fusible toy bead 6, and the periphery of the bead placing portion 31 is surrounded like a bank. Adjacent bead placing portions 31 inside the second cavity 3 are partitioned by partition walls 33 that are curved in a concave arc.

Protruding walls 34 higher than the partition walls 33 are formed at boundaries between the plurality of adjacent bead placing portions 31 located inside the second cavity 3. The bead placing portion 31 is surrounded by the partition wall 33 or the protruding wall 34, and thus the bead placing portion 31 can stably support the fusible toy bead 6 even at an inclined position within the second cavity 3.

Adjacent bead placing portions 31 at the edge portion of the second cavity 3 are also partitioned by the partition wall 33.

The hinge portion 13 is a flat and flexible member. The hinge portion 13 is formed such that the first mold member 11 and the second mold member 12 can be bent to bring the respective mold contact surfaces 11a1 and 12a1 into contact with each other (see a section A in FIG. 3).

Next, a using example of the assembly support tool 1A will be described. A user (player) first sets the assembly support tool 1A in an unfolded state, and places the assembly support tool 1A on a working surface of a desk or the like with the insides of the first cavity 2 and second cavity 3 facing upward.

The fusible toy beads 6 are placed in the bead placing portions 21 and 31 in the first cavity 2 and the second cavity 3. The fusible toy beads 6 are placed toward the outer peripheral edges of the cavities (first cavity 2 and second cavity 3), for example, starting from the inner bead placing portion 21 and 31 farther from the outer peripheral edges of the cavities. Accordingly, the fusible toy beads 6 are placed in the first cavity 2 and the second cavity 3 in a semi-spherical segment bowl-like shape, with the fusible toy beads 6 substantially in contact with each other.

Next, water is sprayed onto the plurality of fusible toy beads 6 arranged in the first cavity 2 and the second cavity 3 using a spray bottle or the like to wet all the fusible toy beads 6. Accordingly, part of the water-soluble resin contained in the fusible toy beads 6 is dissolved, so that the fusible toy beads 6 are connected together.

Thereafter, as shown in FIG. 3, the first mold member 11 and the second mold member 12 are closed together such that the mold contact surfaces 11a1 and 12a1 face each other. For example, if the first mold member 11 and the second mold member 12 are closed with the hinge portion 13 facing downwards, the mold can be easily closed without the insufficiently fused fusible toy beads 6 falling out of the cavities or causing deformation.

When the first mold member 11 and the second mold member 12 are closed together, the positioning protrusions 111 engage with the positioning holes 122, and the positioning protrusions 121 engage with the positioning holes 112. Accordingly, positions of the first cavity 2 and the second cavity 3 are accurately aligned.

Accordingly, the fusible toy bead 6 located on the outer peripheral edge side of the first cavity 2 and the fusible toy bead 6 located on the outer peripheral edge side of the second cavity 3 are in contact with each other while in a wet state, and are connected to each other.

When the dissolved water-soluble resin dries (or dries to a certain extent), the adjacent fusible toy beads 6 are fused together. Next, the first mold member 11 and the second mold member 12 are opened, and an assembly 7 of the fusible toy beads 6 can be taken out.

When the assembly support tool 1A according to the first embodiment is used, a hollow three-dimensional assembly 7 which has a spherical segment shape can be easily produced. Therefore, the assembly support tool 1A can be used, for example, to produce the assembly 7 resembling ice cream scooped with a scooper by the fusible toy beads 6.

### Second Embodiment

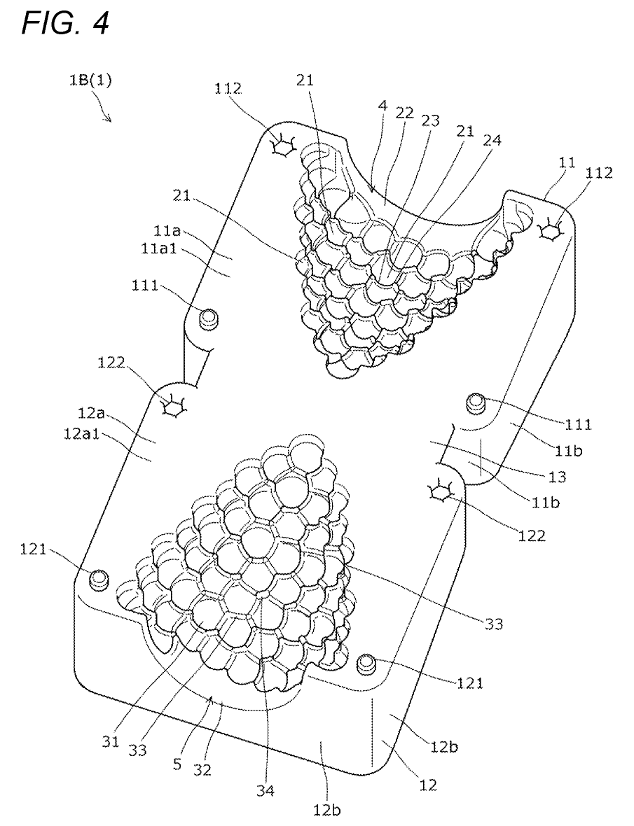

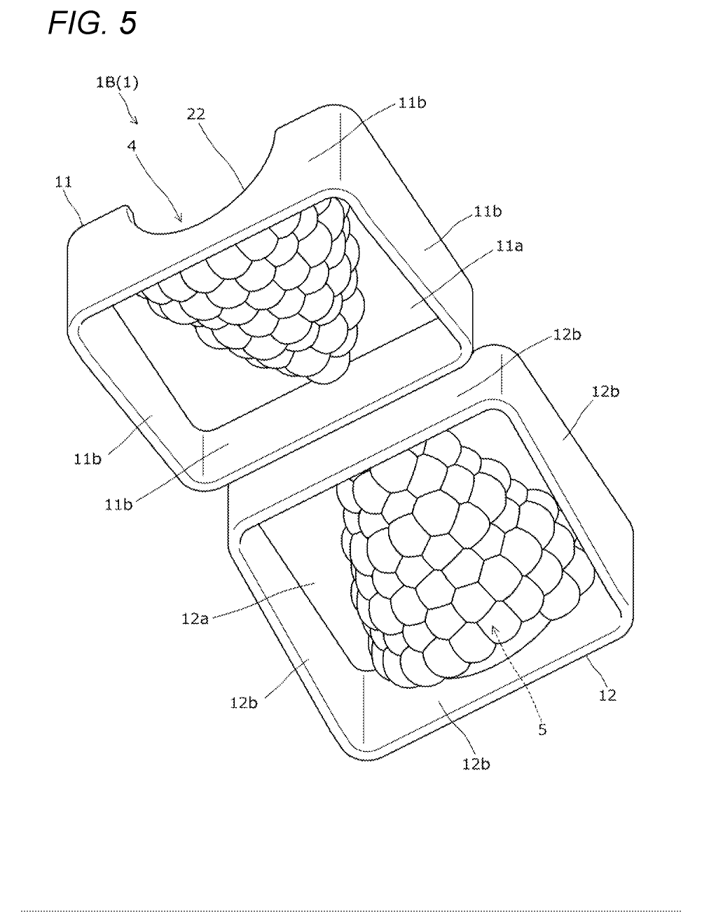

Next, a second embodiment of the present disclosure will be described with reference to FIGS. 4 and 5. FIG. 4 is a planar perspective view of an assembly support tool 1B(1) according to the second embodiment. FIG. 5 is a bottom perspective view of the assembly support tool 1B according to the second embodiment. The assembly support tool 1B is a support tool that can produce a three-dimensional assembly having a shape different from that of the first embodiment.

Note that in the description of the second embodiment, the description of components similar to those of the first embodiment will be omitted or simplified.

A first cavity 4 and a second cavity 5 of the assembly support tool 1B are formed such that the bead placing portions 21 and 31 are disposed obliquely with respect to opening surfaces of notch portions (first notch portion 22 and second notch portion 32), and each of inner diameters thereof narrows as a distance from the notch portion increases. When the assembly support tool 1B according to the second embodiment is used, a hollow three-dimensional assembly which has a conical shape can be easily produced. Therefore, the assembly support tool 1B can be used to produce, for example, an assembly resembling soft-serve ice cream by the fusible toy beads 6.

The embodiments of the present disclosure described above allow for providing an assembly support tool 1 for a fusible toy bead according to the following aspects.

An assembly support tool for a fusible toy bead according to a first aspect includes: a first mold member including a first cavity; a second mold member including a second cavity; a hinge portion connecting the first mold member and the second mold member such that the first mold member and the second mold member are able to be closed or opened, in which the first cavity and the second cavity include a plurality of bead placing portions for positioning the fusible toy bead.

According to this aspect, an assembly of the fusible toy beads 6 is produced in half, and then the first mold member 11 and the second mold member 12 are closed together to combine two half assemblies into a single assembly. The mold can also be manually opened, and the assembly obtained by fusing can be easily taken out. Therefore, a three-dimensional assembly can be easily produced.

In the assembly support tool for a fusible toy bead according to a second aspect, the first mold member includes a first notch portion at a position adjacent to the first cavity, the second mold member includes a second notch portion at a position adjacent to the second cavity, and the first notch portion and the second notch portion are connected to an external space when the first mold member and the second mold member are closed.

According to this aspect, an assembly provided with an opening in a part thereof can be produced. If the first notch portion 22 and the second notch portion 32 are provided on sides opposite to the hinge portion 13, the fusible toy beads 6 placed in the bead placing portions 21 and 31 can be prevented from deforming in a case of closing the mold. The user can easily open the first mold member 11 and the second mold member 12 by, for example, hooking fingers on the first notch portion 22 and the second notch portion 32.

In the assembly support tool for a fusible toy bead according to a third aspect, the hinge portion is a flat and flexible member.

According to this aspect, the integrated assembly support tool 1 can be easily constructed by connecting the first mold member 11 and the second mold member 12. By forming the hinge portion 13 into a flat plate, it is possible to reduce deviation in a closed position of the first mold member 11 and the second mold member 12 in a case of bending the hinge portion 13. The hinge portion 13 is made of a flexible member, so that it is possible to easily close the assembly support tool 1.

In the assembly support tool for a fusible toy bead according to a fourth aspect, the first mold member includes a first engaging portion, and the second mold member includes a second engaged portion engageable with and releasable from the first engaging portion.

According to this aspect, positions of the first cavity 2, 4 and the second cavity 3, 5 can be easily aligned in the case of closing the mold.

In the assembly support tool for a fusible toy bead according to a fifth aspect, the first mold member includes a first engaged portion, and the second mold member includes a second engaging portion engageable with and releasable from the first engaged portion.

According to this aspect, the positions of the first cavity 2, 4 and the second cavity 3, 5 can be further easily aligned in the case of closing the mold.

In the assembly support tool for a fusible toy bead according to a sixth aspect, the second mold member includes a core portion instead of the second cavity or together with the second cavity.

According to this aspect, the assembly support tool 1 is not limited to producing an assembly having a surface in a convex shape (for example, a spherical shape, a spherical segment shape, and a conical shape), and can produce a variety of three-dimensional assemblies including concave portions.

The embodiment of the present disclosure has been described above. The aspects of the present disclosure are not limited to this embodiment. For example, in the present embodiment, the configuration has been described in which cavities (first cavity 2 and second cavity 3) are respectively provided in the first mold member 11 and the second mold member 12, but the cavity (first cavity 2 or second cavity 3) (concave portion) of one of the first mold member 11 and the second mold member 12 may serve as a core portion (convex portion). For example, the second mold member 12 may have a core portion instead of the second cavity 3 or together with the second cavity 3. When the core portion is provided together with the second cavity 3, the core portion may be provided on a part of the second cavity 3, or may be provided adjacent to the second cavity 3.

In the present embodiment, the configuration has been described in which the first cavity 2 includes the positioning protrusions 111 as the first engaging portions and the positioning holes 112 as the first engaged portions, and the second cavity 3 includes the positioning protrusions 121 as the second engaging portions and the positioning holes 122 as the second engaged portions, but the present disclosure is not limited thereto. For example, the first cavity 2 may include the positioning protrusions 111 and the second cavity 3 may include the positioning holes 122, or the first cavity 2 may include the positioning holes 112 and the second cavity 3 may include the positioning protrusions 121.

In the present embodiment, the configuration has been described in which the fusible toy beads 6 are made of a resin, which is a water-soluble material, and the wet fusible toy beads 6 are fused to each other by being brought into contact with each other in a wet state and then being dried, but the present disclosure is not limited thereto. For example, the fusible toy beads 6 may be configured to be fused to each other by thermal fusing.

The bead placing portion 21 adjacent to the mold contact surface 11a1 may be formed to store half of the fusible toy bead 6. In this case, the remaining half of the fusible toy bead 6 is stored in the bead placing portion 31 adjacent to the mold contact surface 12a1 of the second cavity 3.

In the present embodiment, the configuration has been described in which the first cavity 2, 4 and the second cavity 3, 5 respectively have bead placing portions 21 and 31 provided over the entire surface, but one of or both the first the first cavity 2, 4 and the second cavity 3, 5 may have the bead placing portions 21 and 31 in a part thereof. Accordingly, a more complex three-dimensional assembly can be produced.

Each of the first cavity 2, 4 and the second cavity 3, 5 may be formed in a semi-tubular shape. For example, each of the first cavity 2, 4 and the second cavity 3, 5 may be formed in a semi-cylindrical shape. Accordingly, a tubular assembly can be produced.

In the present embodiment, the engaging portions are described as the positioning protrusions and the engaged portions are described as the positioning holes, but these may be reversed. The engaging portions and the engaged portions may have other structures as long as these portions are configured to engage with each other and be positioned.

What is claimed is:

1. An assembly support tool for a fusible toy bead, the assembly support tool comprising:
a first mold member including a first cavity;
a second mold member including a second cavity; and
a hinge portion connecting the first mold member and the second mold member such that the first mold member and the second mold member are able to be closed or opened, wherein
the first cavity and the second cavity include a plurality of bead placing portions for positioning the fusible toy bead.

2. The assembly support tool for the fusible toy bead according to claim 1, wherein
the first mold member includes a first notch portion at a position adjacent to the first cavity,
the second mold member includes a second notch portion at a position adjacent to the second cavity, and
the first notch portion and the second notch portion are connected to an external space when the first mold member and the second mold member are closed.

3. The assembly support tool for the fusible toy bead according to claim 1, wherein
the hinge portion is a flat and flexible member.

4. The assembly support tool for the fusible toy bead according to claim 1, wherein
the first mold member includes a first engaging portion, and
the second mold member includes a second engaged portion engageable with and releasable from the first engaging portion.

5. The assembly support tool for the fusible toy bead according to claim 4, wherein
the first mold member includes a first engaged portion, and
the second mold member includes a second engaging portion engageable with and releasable from the first engaged portion.

6. The assembly support tool for the fusible toy bead according to claim 1, wherein
the second mold member includes a core portion instead of the second cavity or together with the second cavity.
